(19) United States
(12) Patent Application Publication
(10) Pub. No.: US 2024/0400362 A1
(43) Pub. Date: Dec. 5, 2024

(54) CONVEYANCE APPARATUS

(71) Applicant: Daifuku Co., Ltd., Osaka (JP)

(72) Inventors: Takeyoshi KITAOKA, Shiga (JP); Tomohiko KAWASHIMA, Shiga (JP); Ryo NAKAGAWA, Shiga (JP)

(21) Appl. No.: 18/677,349

(22) Filed: May 29, 2024

(30) Foreign Application Priority Data
Jun. 5, 2023 (JP) 2023-092607

(51) Int. Cl. B66F 9/19; B66F 9/07; B66F 9/20

(52) U.S. Cl. CPC B66F 9/195; B66F 9/205; B66F 9/07

(57) ABSTRACT

A conveyance apparatus (carriage main part) includes a link mechanism that advances and retreats a holding unit horizontally with respect to a link mechanism support unit, and includes a pair of multi-joint arms that connects the link mechanism support unit and the holding unit. The cable is fixed to the link mechanism support unit by extending from a portion thereof fixed to the holding unit in a retreating direction of an advancing and retreating direction, and then, being bent back in an advancing direction, and as the holding unit advances, the bent-back position F of the cable also advances.

### CROSS-REFERENCE TO RELATED APPLICATIONS

This application is based on and claims priority from Japanese Patent Application No. 2023-092607, filed on Jun. 5, 2023, with the Japan Patent Office, the disclosure of which is incorporated herein in its entirety by reference.

### TECHNICAL FIELD

The present disclosure relates to a conveyance apparatus.

### BACKGROUND

Conveyance apparatuses conveying articles by loading the articles on a carriage are known. The carriage is provided with a holding unit having, for example, a fork that may advance and retreat with respect to the body of the carriage to pick up an article from a storage shelf, etc., and place the article on a storage shelf, etc., in the state of protruding from the body of the carriage. Further, the carriage is provided with a link mechanism that advances and retreats the holding unit (see, e.g., Japanese Patent No. 5590411).

### SUMMARY

According to an aspect of the present disclosure, a conveyance apparatus includes a base unit; a link mechanism support unit provided on the base unit; a holding unit that holds a conveyance target object; a link mechanism that includes a pair of multi-joint arms that connects the link mechanism support unit and the holding unit, and advances and retreats the holding unit horizontally with respect to the link mechanism support unit; and a cable fixed to the holding unit and the link mechanism support unit. The cable is fixed to the link mechanism support unit by extending from a portion thereof fixed to the holding unit in a retreating direction of an advancing and retreating direction of the holding unit, and then, being bent back in an advancing direction, and as the holding unit advances along with the portion of the cable fixed to the holding unit, a bent-back position of the cable between the portion of the cable fixed to the holding unit and the portion fixed to the link mechanism support unit also advances.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a stacker crane to which a conveyance apparatus of the present disclosure is applied.

FIG. 2 is a perspective view illustrating a main part of a carriage, which is the conveyance apparatus according to an embodiment of the present disclosure, and illustrates a state where a holding unit is at a retreat position when the holding unit retreats most.

FIG. 3 is a perspective view illustrating a main part of a carriage, which is the conveyance apparatus according to an embodiment of the present disclosure, and illustrates a state where a holding unit is at a retracted position when the holding unit retreats most.

FIG. 4 is a perspective view illustrating a main part of a carriage, which is the conveyance apparatus according to an embodiment of the present disclosure, and illustrates a state where the holding unit is at an advance position when the holding unit advances most.

FIG. 5 is a side view illustrating a main part of a carriage, which is the conveyance apparatus according to an embodiment of the present disclosure, and illustrates a state where the holding unit is at a retreat position when the holding unit retreats most.

FIG. 6 is a side view illustrating a main part of a carriage, which is the conveyance apparatus according to an embodiment of the present disclosure, and illustrates a state where the holding unit is at an advance position when the holding unit advances most.

FIG. 7 is a cross-sectional view of a cable of the conveyance apparatus according to an embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

In the conveyance apparatus of Japanese Patent No. 5590411, a sensor is provided in the holding unit for the purpose of, for example, detecting an article or the posture of the holding unit. Thus, cables (electric wires) are necessary to transmit signals to the movable holding unit. It is required to facilitate the wiring of the cables when manufacturing a carriage. An aspect of the present disclosure implements a conveyance apparatus, which may facilitate the wiring of the cables for the movable holding unit.

In order to solve the problem described above, a conveyance apparatus according to an aspect of the present disclosure includes a base unit; a link mechanism support unit provided on the base unit; a holding unit that holds a conveyance target object; a link mechanism that includes a pair of multi-joint arms that connects the link mechanism support unit and the holding unit, and advances and retreats the holding unit horizontally with respect to the link mechanism support; and a cable fixed to the holding unit and the link mechanism support unit. The cable is fixed to the link mechanism support unit by extending from a portion thereof fixed to the holding unit in a retreating direction of an advancing and retreating direction of the holding unit, and then, being bent back in an advancing direction, and as the holding unit advances along with the portion of the cable fixed to the holding unit, a bent-back position of the cable between the portion of the cable fixed to the holding unit and the portion fixed to the link mechanism support unit also advances.

According to an aspect of the present disclosure, it is possible to implement a conveyance apparatus, in which the wiring of cables for the movable holding unit may be easily performed.

### Embodiment

### <Outline of Stacker Crane>

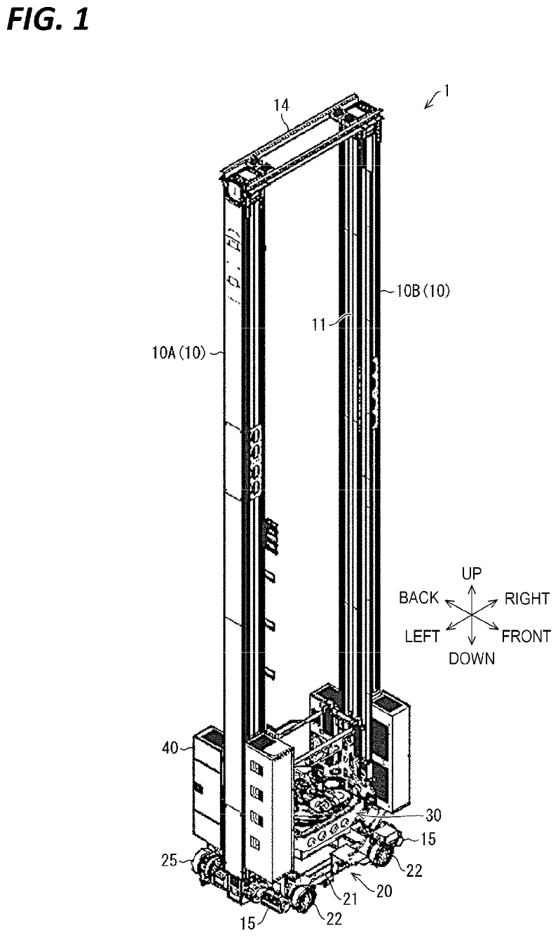

Hereinafter, an embodiment of the present disclosure will be described with reference to the drawings. FIG. 1 is a view illustrating a stacker crane 1 as an example of an apparatus to which the present disclosure is applied. For the convenience of description of FIG. 1, the up-down direction, the front-back direction, and the left-right direction are defined as indicated by arrows in FIG. 1. The up-down direction is the vertical direction. The front-back direction and the left-right direction are parallel to the horizontal plane, and are each orthogonal to the vertical direction. The front-back direction is perpendicular to the left-right direction.

The stacker crane 1 is a conveyance apparatus that conveys an article as a conveyance target object by traveling along travel rails laid in the left-right direction. The stacker crane 1 includes a mast 10, a travel bogie 20, a carriage 30, and a control box 40. The control box 40 accommodates a control unit, which is an information processing apparatus that controls each part of the stacker crane 1.

The travel bogie 20 includes a bogie frame 21 and a travel motor unit 25. The bogie frame 21 supports wheels 22 running on the travel rails. The travel motor unit 25 drives at least a portion of the wheels 22, so that the stacker crane 1 autonomously travels on the travel rails.

The mast 10 is a columnar member that stands on the bogie frame 21 while extending in the up-down direction. The stacker crane 1 includes a first mast 10A and a second mast 10B as a pair of masts 10. The first mast 10A and the second mast 10B are disposed on the travel bogie 20 while being spaced apart from each other in the left-right direction, i.e., in the traveling direction of the stacker crane 1.

The carriage 30 is disposed between the first mast 10A and the second mast 10B. In each of the facing sides of the first mast 10A and the second mast 10B, a lifting guide rail 11 is provided to guide the carriage 30 along the corresponding mast. An upper frame 14 is provided on the mast 10. The upper frame 14 is provided to connect the upper end of the first mast 10A and the upper end of the second mast 10B to each other.

A lifting motor unit 15 is provided below the mast 10 to move the carriage 30 up and down with respect to the mast 10. A wire or belt driven by the lifting motor unit 15 is connected to the frame of the carriage 30, so that the carriage 30 may be moved up and down along the mast 10.

While the stacker crane 1 has been described as an example of the apparatus to which the present disclosure is applied, the apparatus to which the present disclosure is applied is not limited to the stacker crane 1. For example, the apparatus to which the present disclosure is applied may be a lifter equipped with a carriage 30 serving as a lifting base that moves, for example, the mast or the frame up and down.

The carriage 30 serving as a lifting base may be regarded as the apparatus to which the present disclosure is applied. Further, the apparatus to which the present disclosure is applied may be a conveyance vehicle in which the main part of the carriage 30 (a carriage main part 100 to be described later) is provided on a bogie traveling on a predetermined track or a trackless traveling bogie.

### <Carriage Main Part: Outline>

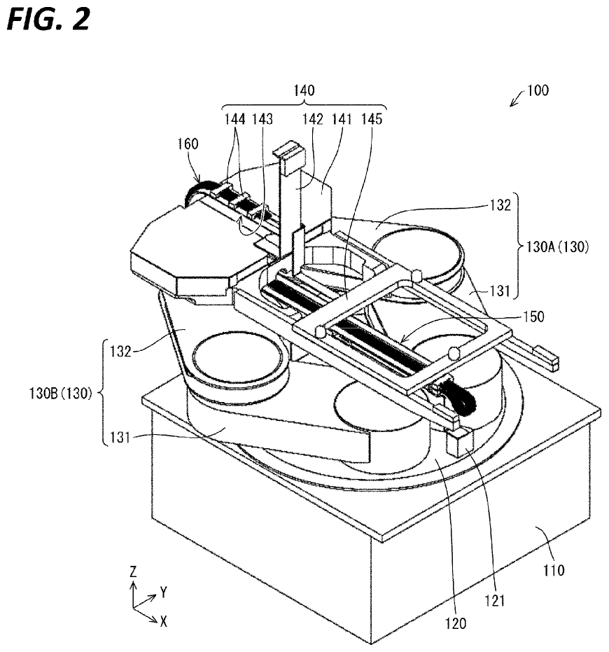

FIGS. 2 to 6 are views illustrating the carriage main part 100, which is a key part of the carriage 30 and fixed to the frame of the carriage 30. The carriage main part 100 performs the transfer of an article P, which is a conveyance target object. As illustrated in each figure, the XYZ coordinate system is defined such that the Z axis corresponds to the vertical direction, and the XY plane corresponds to the horizontal plane.

The carriage main part 100 is provided with a holding unit 140 that lifts (pick) up, disposes (places), and further, holds the article P, which is the conveyance target object. In the present embodiment, the holding unit 140 includes a fork 145 protruding horizontally from a holding unit body 141, and the fork 145 may lift up and hold the article P placed on, for example, a storage shelf.

The method of holding the article by the holding unit 140 is not limited to using the fork 145, and any well-known appropriate method may be applied. For example, the method of holding the article may be implemented by gripping the article, using an engagement mechanism, or adsorbing the article by a magnetic force or vacuum.

The carriage main part 100 includes a base unit 110, a link mechanism support unit 120, a link mechanism 130, a holding unit 140, a cable guide 150, and a cable 160. The carriage main part 100 itself, which performs the transfer of the article P, may be regarded as the conveyance apparatus corresponding to an embodiment of the present disclosure. The bottom surface of the base unit 110 is substantially the horizontal plane, i.e., the main plane of the bottom surface of the base unit 110 is parallel with the XY plane. The link mechanism support unit 120 is supported by the base unit 110 to be rotatable around the vertical axis (parallel with the Z axis).

### <Carriage Main Part: Link Mechanism>

The link mechanism 130 is supported by the link mechanism support unit 120. The link mechanism 130 is configured with a pair of multi-joint arms 130A and 130B that advances and retreats the holding unit 140 horizontally with respect to the link mechanism support unit 120. Since the link mechanism support unit 120 supporting the link mechanism 130 may rotate with respect to the base unit 110, the carriage 30 in the stacker crane 1 may transfer the article in the state of protruding from the base unit 110 in both the forward and backward directions of FIG. 1.

Here, in each of FIGS. 2 to 6, it is assumed that the rotation angle of the link mechanism support unit 120 with respect to the base unit 110 is commonly fixed, and the advancing/retreating direction of the holding unit 140 is parallel with the X-axis. In each figure, it is assumed that the direction in which the holding unit 140 advances to pick up the article from a storage shelf or the like is the positive X-axis direction, and the direction in which the holding unit 140 retreats to hold the article above the base unit 110 after picking up the article from the storage shelf or the like is the negative X-axis direction.

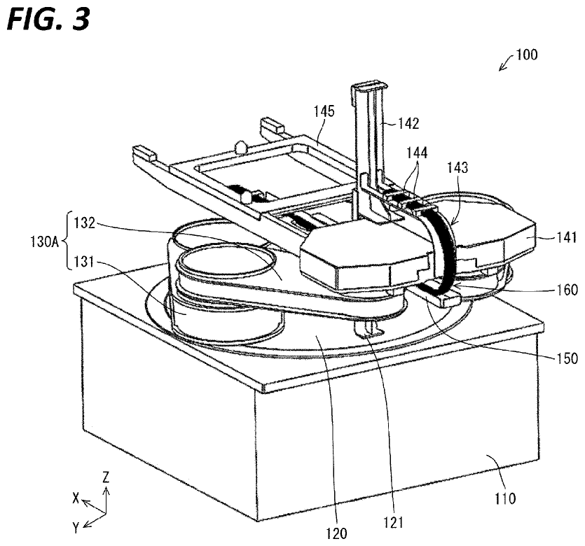

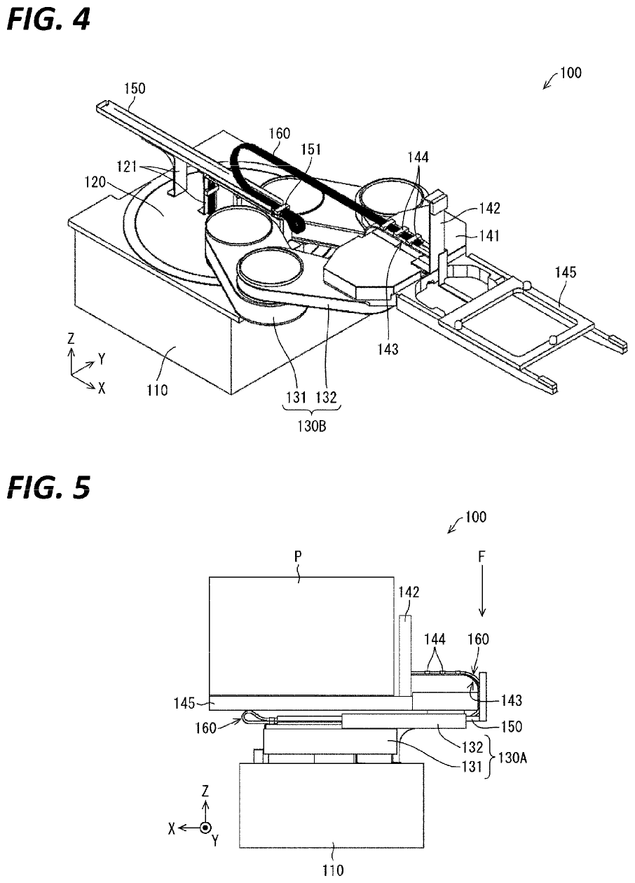

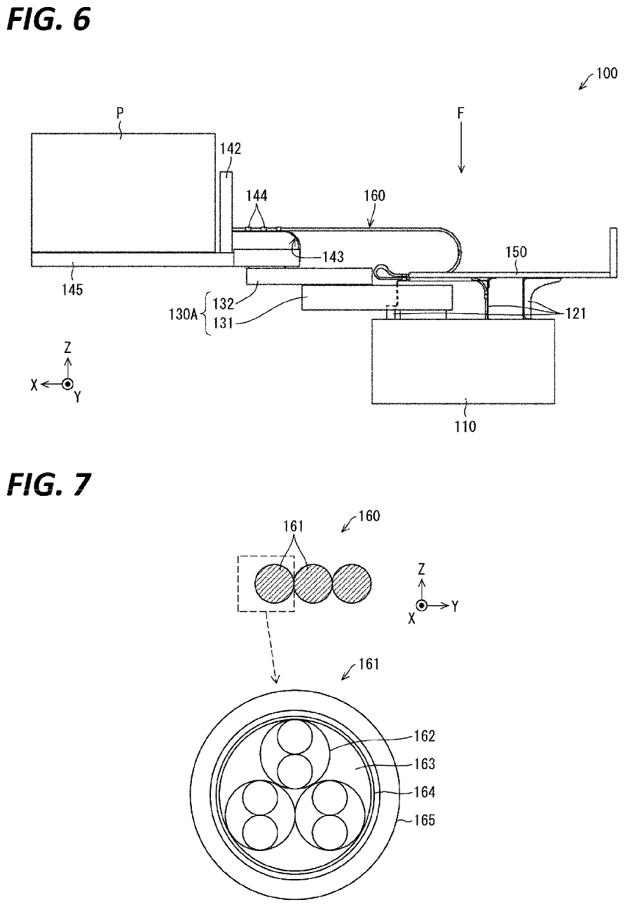

FIGS. 2 and 3 are perspective views illustrating the carriage main part 100 when the holding unit 140 is at the retreat position where the holding unit 140 retreats most. FIG. 4 is a perspective view illustrating the carriage main part 100 when the holding unit 140 is at the advance position where the holding unit 140 advances most. FIG. 5 is a side view illustrating the carriage main part 100 when the holding unit 140 is at the retreat position where the holding unit 140 retreats most. FIG. 6 is a side view illustrating the carriage main part 100 when the holding unit 140 is at the advance position where the holding unit 140 advances most.

Each of the multi-joint arm 130A and the multi-joint arm 130B has a first arm 131 pivotably connected to the link mechanism support unit 120 and a second arm 132 pivotably connected to each of the first arm 131 and the holding unit body 141 of the holding unit 140. The multi-joint arm 130A and the multi-joint arm 130B are configured to be mirror symmetrical to each other with respect to the plane parallel with the XZ plane.

The multi-joint arm 130A and the multi-joint arm 130B are robot arms also called selective compliance assembly robot arms (SCARA). Thus, the link mechanism 130 that enables the advancing and retreating movement of the holding unit 140 may be called a SCARA-type advancing and retreating mechanism. The SCARA-type advancing and retreating mechanism is characterized by reducing the generation of dust and the scattering of grease, as compared to, for example, an advancing and retreating mechanism that uses a fork that move back and forth on rails.

The opening angle of the pair of first arms 131 of the link mechanism 130 is defined as the angle between the longitudinal directions of the respective first arms 131, and the angle having the negative X-axis direction in, for example, FIG. 2 at the center thereof. As illustrated in FIGS. 2 and 3, the opening angle is the smallest when the holding unit 140 is at the retreat position, and is less than 180°. As illustrated in FIG. 4, the opening angle is the largest when the holding unit 140 is at the advance position, and is more than 180°. The opening angle increases as the link mechanism 130 advances the holding unit 140, and decreases as the link mechanism 130 retreats the holding unit 140.

### <Carriage Main Part: Holding Unit>

The holding unit 140 includes a connection member 142, a cable drawing unit 143, and a cable fixing mechanism 144, in addition to the holding unit body 141 and the fork 145 described above. The connection member 142 is a member standing on the holding unit body 141 to fix the cable drawing unit 143 to the holding unit body 141.

As illustrated in FIGS. 5 and 6, the connection member 142 also serves to prevent the collapse of the article P, which is a conveyance target object to be conveyed by the carriage main part 100. The cable fixing mechanism 144 is a member that fixes the cable 160 on the cable drawing unit 143. A sensor (not illustrated) is appropriately provided in the holding unit 140 for the purpose of, for example, detecting the article or detecting the posture of the holding unit 140.

Thus, in order to supply a power to the sensor of the holding unit 140 or transmit signals to/from the sensor, a cable 160 is provided in the carriage main part 100 to be fixed to the holding unit 140 and the link mechanism support unit 120, which will be described in detail later. Meanwhile, the holding unit 140 may be further provided with a powered mechanism for holding articles, without being limited to the sensor. In this case, the cable 160 may be used to supply a power to the mechanism or transmit signals to/from the mechanism.

### <Carriage Main Part: Arrangement of Cable and Cable Guide, Etc.>

The fixing of the cable 160 to the holding unit 140 is performed in the cable drawing unit 143 of the holding unit 140. The cable drawing unit 143 is fixed to the holding unit body 141 by the connection member 142, and guides the cable 160 above the holding unit body 141. The cable 160 is fixed by the cable fixing mechanism 144 on the cable drawing unit 143 to extend in the retreating direction (negative X-axis direction) of the advancing/retreating direction of the holding unit 140.

The cable drawing unit 143 is curved to be gradually directed downward as being extended in the retreating direction of the advancing/retreating direction of the holding unit 140 (negative x-axis direction). Thus, as illustrated in FIGS. 2, 3, and 5, when the holding unit 140 is at the retreat position, the cable 160 is guided by the cable drawing unit 143 to be gradually directed downward (toward the negative Z-axis direction) as being away from the cable fixing mechanism 144, i.e., extended in the retreating direction of the advancing/retreating direction of the holding unit 140 (negative X-axis direction).

As being further away from the cable fixing mechanism 144, the cable 160 is turned around toward the advancing direction of the advancing/retreating direction of the holding unit 140 (positive X-axis direction) without being in contact with the cable drawing unit 143 or the cable guide 150. That is, the cable 160 is drawn from the cable drawing unit 143 in the retreating direction of the advancing/retreating direction of the holding unit 140 (negative X-axis direction), and then, bent back to be turn around toward the advancing direction of the advancing/retreating direction of the holding unit 140 (positive X-axis direction). The bent-back position of the cable 160 in the advancing/retreating direction of the holding unit 140 (X-axis direction) is indicated by the sign F in FIG. 5.

The cable 160 bent back in the advancing direction of the advancing/retreating direction of the holding unit 140 is in a state where a portion thereof is placed on the cable guide 150 provided below the cable drawing unit 143 (in the negative Z-axis direction). As illustrated in FIGS. 2, 3, and 5, when the holding unit 140 is at the retreat position, the cable 160 bent back at the position F is kept horizontal in a state of being placed on the cable guide 150 at a point further away from the cable drawing unit 143.

The cable guide 150 is an elongated member that extends in the advancing/retreating direction (X-axis direction) of the holding unit 140. The cable guide 150 is fixed to the link mechanism support unit 120 via connecting members 121. The cable guide 150 is a plate material having a horizontal surface (parallel to the XY plane) as the upper surface thereof such that the cable 160 is disposed to be in contact with or separable from the cable guide 150. In order to prevent the deviation of the disposition of the cable 160, the plate material may be bent upward around the horizontal surface of the cable guide 150, as illustrated in FIGS. 3 and 4. The disposition of the cable guide 150 will be discussed later.

Near the end of the cable guide 150 in the advancing direction of the advancing/retreating direction of the holding unit 140 (positive X-axis direction), the cable 160 is fixed to the cable guide 150 by the cable fixing mechanism 151. In the cable 160, the portion is not fixed, which extends from the point where the cable 160 is fixed to the cable drawing unit 143 by the connecting member 142 to the point where the cable 160 is fixed to the cable guide 150 by the cable fixing mechanism 151.

Thus, it is possible to deform the portion of the cable 160 that extends from the point where the cable 160 is fixed to the cable drawing unit 143 by the connecting member 142 to the point where the cable 160 is fixed to the cable guide 150 by the cable fixing mechanism 151. When the holding unit 140 advances by the link mechanism 130, the portion of the cable 160 fixed to the holding unit 140 also advances together with the holding unit 140 (moves in the positive X-axis direction).

Then, as illustrated in FIGS. 4 and 6, the portion of the cable 160 is pulled by the holding unit 140 in the direction in which the portion extends, and the bent-back position F of the cable 160 moves in the advancing direction of the advancing/retreating direction of the holding unit 140 (positive X-axis direction). As the holding unit 140 advances by the link mechanism 130, the portion of the cable 160 placed on the cable guide 150 is separated from the cable guide 150 in turn from the retreating direction of the advancing/retreating direction (negative X-axis direction).

Conversely, when the holding unit 140 retreats by the link mechanism 130 from the advance position where the holding unit 140 advances most, the portion of the cable 160 fixed to the holding unit 140 also retreats together with the holding unit 140 (moves in the negative X-axis direction). Then, the portion of the cable 160 is pushed by the holding unit 140 in the direction in which the portion extends, and the bent-back position F of the cable 160 moves in the retreating direction of the advancing/retreating direction of the holding unit 140 (negative X-axis direction).

As the holding unit 140 retreats by the link mechanism 130, the portion of the cable 160 that is separated from the cable guide 150 is placed on the cable guide 150 in turn from the side of the advancing direction of the advancing/retreating direction (positive X-axis direction).

As illustrated in, for example, FIG. 2, the cable fixing mechanism 151 of the cable guide 150 may fix the cable 160 at the base of a loop formed by a portion of the cable 160. The looped cable 160 is directed again toward the retreating direction of the advancing/retreating direction of the holding unit 140 (negative X-axis direction) as being further away from the side of the holding unit 140, and then, advances toward the link mechanism support unit 120 to be connected to a required circuit inside the base unit 110.

In order to achieve the above-described movement of the cable 160, the cable guide 150 may be disposed as follows. The end of the cable guide 150 on the side of the retreating direction of the advancing/retreating direction of the holding unit 140 (negative X-axis direction) is disposed further on the side of the retreating direction of the advancing/retreating direction of the holding unit 140 (negative X-axis direction) than the holding unit 140 at the retreating position.

This is because the cable guide 150 may guide the cable 160 even when the holding unit 140 retreats most. That is, when the holding unit 140 is at the retreat position, the bent-back position F of the cable 160 is located further on the side of the retreating direction of the advancing/retreating direction of the holding unit 140 (negative X-axis direction) than the holding unit 140.

The end of the cable guide 150 on the side of the advancing direction of the advancing/retreating direction of the holding unit 140 (positive X-axis direction) is disposed further on the side of the advancing direction of the advancing/retreating direction of the holding unit 140 (positive X-axis direction) than the pivoting axis of the first arm 131 pivotably connected to the link mechanism support unit 120. That is, the position of the cable fixing mechanism 151 of the cable guide 150 is located further on the side of the advancing direction of the advancing/retreating direction of the holding unit 140 (positive X-axis direction) than the pivoting axis. This is because the cable 160 is fixed to the cable guide 150 at the portion disposed on the cable guide 150 even when the holding unit 140 advances most. This is also because the cable 160 may be sufficiently drawn from the side of the link mechanism support unit 120 to the holding unit 140 even when the holding unit 140 advances most.

The cable guide 150 is disposed between the pair of second arms 132, at the height where the second arm 132 of the link mechanism 130 is disposed in the vertical direction (Z-axis direction). That is, the cable guide 150 is disposed at the higher height than the height at which the first arm 131 of the link mechanism 130 is disposed in the vertical direction (Z-axis direction) (the position on the side of the positive Z-axis direction), without interfering with the pair of first arms 131.

Thus, at the point where the second arm 132 is pivotably connected to the holding unit body 141 of the holding unit 140, a gap is formed between the pair of second arms 132 such that the cable guide 150 passes through the gap. That is, the pair of second arms 132 are pivotably connected to the holding unit body 141 of the holding unit 140 while forming a gap for disposing the cable guide 150 therein.

In other words, the cable 160, which is drawn from the holding unit 140 above the holding unit body 141 to extend in the negative X-axis direction, is bent back in the positive X-axis direction, and then, disposed between the pair of second arms 132 at the height where the second arm 132 of the link mechanism 130 is disposed. Further, at the point where the second arm 132 is pivotably connected to the holding unit body 141 of the holding unit 140, a gap is formed between the pair of second arms 132 such that the cable 160 passes through the gap.

The cable guide 150 is fixed onto the link mechanism support unit 120 as described above by three connecting members 121 standing on the link mechanism support unit 120. Two of the three connecting members 121 are connected to the cable guide 150 near both ends of the cable guide 150, respectively. The other connecting member 121 is connected to the cable guide 150 near the center of the cable guide 150.

Since the cable 160 moves along with the advancing/retreating movement of the holding unit 140 without interfering with any part of the link mechanism 130, the cable 160 is disposed in the vertical plane along the advancing/retreating direction of the holding unit 140, at the center of the link mechanism 130. In the link mechanism 130, the connection mechanism between the first arm 131 and the link mechanism support unit 120 needs to be sturdier than the connection mechanism between the holding unit body 141 and the second arm 132 in order to also support the load of the link mechanism 130. Meanwhile, these connection mechanisms are pivotable, and include, for example, a gear box. Accordingly, the connection mechanism between the first arm 131 and the link mechanism support unit 120 is difficult to become compact, as compared to the connection mechanism between the holding unit body 141 and the second arm 132.

Thus, the carriage main part 100 of the present embodiment is configured such that at the center of the link mechanism 130, the cable 160 and the cable guide 150 pass through the gap between the pair of second arms 132 at the connection part between the holding unit body 141 and the second arms 132. Meanwhile, when a gap is formed between the first arms 131, at the connection part between the first arms 131 and the link mechanism support unit 120, in order to pass the cable 160 and the cable guide 150 through the gap, the load bearing performance of the link mechanism 130 may be deteriorated.

### <Carriage Main Part: Cable Structure>

As described above, the cable 160 performs a bending movement in the vertical plane along the advancing/retreating direction of the holding unit 140, at the center of the link mechanism 130. Thus, the cable 160 may be configured to not deviate from the vertical plane. FIG. 7 is a cross-sectional view illustrating an example of the configuration of the cable 160 to achieve the configuration.

In FIG. 7, the cable 160 is configured such that a plurality of unit cables 161 is arranged in a row and connected to each other to be formed in a horizontally long shape. That is, the cable 160 has a structure in which the plurality of unit cables 161 are arranged in parallel to have the horizontally long cross section. The unit cables 161 may be connected to each other by, for example, welding.

With this configuration, the cable 160 is hardly deformed in the Y direction. Thus, in the carriage main part 100, the direction in which the unit cables 161 are arranged is the horizontal direction (Y direction), and the cable 160 is prevented from being bent in the Y direction and deviating from the vertical plane.

Meanwhile, FIG. 7 also illustrates an example of the detailed structure of the unit cables 161. Each unit cable 161 includes a plurality of twist pair wires 162. The plurality of twist pair wires 162 are wound by a tape 164 together with a filler 163, and further covered by a sheath made of, for example, polyvinyl chloride (PVC).

### Advantageous Effects

Conventionally, the wiring of a cable from the link mechanism support unit to the holding unit has been performed by communicating the insides of the arms that make up the link mechanism with each other. However, this wiring work is very complicated, and deteriorates the efficiency of manufacturing the conveyance apparatus.

In order to pass the cable through the pivotable connection part in the link mechanism, a hollow shaft along the pivotable axis needs to be provided inside the connection part. However, when this structure is provided in the connection part, it is difficult to achieve both the compact size and the load bearing performance of the link mechanism. However, the present embodiment does not require the shaft necessary to pass the cable through the connection part of the link mechanism. According to the present embodiment, the conveyance apparatus that solves the problem described above may be implemented.

### SUMMARY

According to a first aspect of the present disclosure, a conveyance apparatus includes a base unit; a link mechanism support unit provided on the base unit; a holding unit that holds a conveyance target object; a link mechanism that includes a pair of multi-joint arms that connects the link mechanism support unit and the holding unit, and advances and retreats the holding unit horizontally with respect to the link mechanism support unit; and a cable fixed to the holding unit and the link mechanism support unit. The cable is fixed to the link mechanism support unit by extending from a portion thereof fixed to the holding unit in a retreating direction of an advancing and retreating direction of the holding unit, and then, being bent back in an advancing direction, and as the holding unit advances along with the portion of the cable fixed to the holding unit, a bent-back position of the cable between the portion of the cable fixed to the holding unit and the portion fixed to the link mechanism support unit also advances.

According to a second aspect of the present disclosure, the conveyance apparatus of the first aspect further includes: a cable guide that is fixed to the link mechanism support unit, extends in the advancing and retreating direction, and places thereon at least a portion of the cable in a contacting and separable manner. As the holding unit advances along with the portion of the cable fixed to the holding unit, a portion of the cable disposed on the cable guide is separated from the cable guide in turn from a side of the retreating direction of the advancing and retreating direction.

According to a third aspect of the present disclosure, in the conveyance apparatus of the second aspect, the cable is fixed to the cable guide at the portion of the cable disposed on the cable guide even when the holding unit advances most.

According to a fourth aspect of the present disclosure, in the conveyance apparatus of the second or third aspect, the multi-joint arm includes a first arm pivotably connected to the link mechanism support unit and a second arm pivotably connected to each of the first arm and the holding unit, and the cable guide is disposed at a position between a pair of second arms.

According to a fifth aspect of the present disclosure, in the conveyance apparatus of the fourth aspect, the pair of second arms are pivotably connected to the holding unit while forming a gap for disposing the cable guide therein.

According to a sixth aspect of the present disclosure, in the conveyance apparatus of any one of the first to fifth aspects, the cable has a structure in which a plurality of unit cables is arranged in parallel to have a horizontally long cross section.

According to a seventh aspect of the present disclosure, the conveyance apparatus of any one of the first to sixth aspects further includes a mast, a lifting mechanism unit that moves the base unit up and down along the mast, and a traveling bogie on which the mast stands.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A conveyance apparatus comprising:
a base;
a link mechanism support provided on the base;
a holder configured to hold a conveyance target object;
a link mechanism including a pair of multi-joint arms that connects the link mechanism support and the holder, and configured to advance and retreat the holder horizontally with respect to the link mechanism support; and
a cable fixed to the holder and the link mechanism support,
wherein the cable is fixed to the link mechanism support by extending from a portion thereof fixed to the holder in a retreating direction of an advancing and retreating direction of the holder, and then, being bent back in an advancing direction, and
as the holder advances along with the portion of the cable fixed to the holder, a bent-back position of the cable between the portion of the cable fixed to the holder and the portion fixed to the link mechanism support also advances.

2. The conveyance apparatus according to claim 1, further comprising:
a cable guide fixed to the link mechanism support, extending in the advancing and retreating direction, and configured to place thereon at least a portion of the cable in a contacting and separable manner,
wherein as the holder advances along with the portion of the cable fixed to the holder, a portion of the cable disposed on the cable guide is separated from the cable guide in turn from a side of the retreating direction of the advancing and retreating direction.

3. The conveyance apparatus according to claim 2, wherein the cable is fixed to the cable guide at the portion of the cable disposed on the cable guide even when the holder advances most.

4. The conveyance apparatus according to claim 2, wherein the multi-joint arm includes a first arm pivotably connected to the link mechanism support and a second arm pivotably connected to each of the first arm and the holder, and
the cable guide is disposed at a position between a pair of second arms.

5. The conveyance apparatus according to claim 4, wherein the pair of second arms are pivotably connected to the holder while forming a gap for disposing the cable guide therein.

6. The conveyance apparatus according to claim 1, wherein the cable has a structure in which a plurality of unit cables is arranged in parallel to have a horizontally long cross section.
